(19) United States
(12) Patent Application Publication
(10) Pub. No.: US 2024/0211661 A1
(43) Pub. Date: Jun. 27, 2024

(54) SYSTEMS AND METHODS FOR DESIGNING MANUFACTURING AND MIXING SYSTEMS OF GLASS SUBSTRATES

(71) Applicant: CAIHONG DISPLAY DEVICES CO., LTD., Xianyang (CN)

(72) Inventor: Menghu LI, Xianyang (CN)

(73) Assignee: CAIHONG DISPLAY DEVICES CO., LTD., Xianyang (CN)

(21) Appl. No.: 18/399,648

(22) Filed: Dec. 28, 2023

Related U.S. Application Data
(63) Continuation-in-part of application No. PCT/CN2023/084877, filed on Mar. 29, 2023.

(30) Foreign Application Priority Data
Dec. 22, 2022 (CN) 202211658948.7

(51) Int. Cl. G06F 30/27; G06F 30/12; G06F 30/17

(52) U.S. Cl. CPC G06F 30/27; G06F 30/12; G06F 30/17

(57) ABSTRACT

Embodiments of the present disclosure provide a system and method for designing a manufacturing and mixing system of a glass substrate. The system includes an initial module configured to establish an equivalence relationship for determining at least one initial design parameter of an actual mixing system; a prediction module configured to predict a predicted mixing effect of the actual mixing system; a verification module configured to determine at least one optimized design parameter; a pre-processing module configured to convert the at least one optimized design parameter into a reference code, obtain a label corresponding to reference data of the glass melt, and store the reference code and the label; a recommendation module configured to determine initial melt data of a glass melt to be processed and determine a target label; and determine a target code and convert the target code to at least one target design parameter.

### CROSS-REFERENCE TO RELATED APPLICATION

This application is a Continuation-in-part of International Patent Application No. PCT/CN2023/084877, filed on Mar. 29, 2023, which claims priority to Chinese Application No. 202211658948.7, filed on Dec. 22, 2022, the entire contents of each of which are hereby incorporated by reference.

### TECHNICAL FIELD

The present disclosure relates to the field of manufacturing a glass substrate, and in particular, to a system and a method for designing a manufacturing and mixing system of a glass substrate.

### BACKGROUND

The manufacturing of glass substrates requires the use of a mixing system made of high melting point metal, which is costly. In the design process, it is often preferred to use a smaller mixing system to achieve maximum mixing. To achieve this goal, a shear stress can be increased by increasing a rotation speed of a blade, reducing a gap between a blade of a mixer and a wall of a mixing cavity, etc., so as to achieve a better mixing effect. However, measuring the mixing effect in the actual design process is challenging and can impact the design outcome to a certain extent.

Therefore, there is a need to provide a system and a method for designing a manufacturing and mixing system of a glass substrate to optimize the design of the mixing system.

### SUMMARY

One of the embodiments of the present disclosure provides a system for designing a manufacturing and mixing system of a glass substrate. The system may include an initial module configured to obtain at least one reference design parameter from a reference mixing system, establish an equivalence relationship based on a preset rule, and determine at least one initial design parameter of an actual mixing system based on the equivalence relationship. The system may include a prediction module, wherein the prediction module is configured to predict, based on the at least one initial design parameter, a predicted mixing effect of the actual mixing system when processing a glass melt, and in response to a determination that a first matching degree between the predicted mixing effect and a target mixing effect satisfies a preset condition, generate a verification instruction and send the verification instruction to a verification module. The system may include the verification module, wherein the verification module is configured to: in response to receiving the verification instruction, initiate a verification action to determine a verification mixing effect, and determine a second matching degree between the verification mixing effect and the target mixing effect; in response to a determination that the second matching degree does not satisfy the preset condition, determine at least one optimized design parameter by perform at least one round of update on the at least one initial design parameter in cooperation with an update module; in response to a determination that the second matching degree satisfies the preset condition, determine the at least one initial design parameter as the at least one optimized design parameter; and establish a communication connection with an external test system, the external test system comprising a test terminal and an inspection device, the test terminal being configured to send a test instruction to the verification module and receive a manufacturing instruction from the verification module. The system may include a pre-processing module, wherein the pre-processing module is configured to convert the at least one optimized design parameter into a reference code using an encoder, obtain a label corresponding to reference melt data from a first database in a memory, store the reference code and the label in a second database in the memory, the reference melt data being data of the glass melt corresponding to the at least one optimized design parameter. The system may include recommendation module, wherein the recommendation module is configured to determine, based on a user input, initial melt data of a glass melt to be processed and determine a target label from the first database; determine a target code based on the target label, convert the target code into at least one target design parameter using a decoder corresponding to the encoder; and generate a design simulation diagram corresponding to the at least one target design parameter based on the at least one target design parameter and a simulation instruction, and display the design simulation diagram through a user terminal, wherein the user input is obtained through the user terminal and includes at least one of the initial melt data or the simulation instruction.

One of the embodiments of the present disclosure provides a method for designing a manufacturing and mixing system of a glass substrate. The method may be performed by a system for designing a manufacturing and mixing system of a glass substrate. The method may include: obtaining at least one reference design parameter from a reference mixing system, establishing an equivalence relationship based on a preset rule, and determining at least one initial design parameter of an actual mixing system based on the equivalence relationship; predicting a predicted mixing effect of the actual mixing system when processing a glass melt based on the at least one initial design parameter, and in response to a determination that a first matching degree between the predicted mixing effect and a target mixing effect satisfies a preset condition, generating a verification instruction and sending the verification instruction to a verification module; in response to receiving the verification instruction, initiating a verification action to determine a verification mixing effect, determining a second matching degree between the verification mixing effect and the target mixing effect; in response to a determination that the second matching degree dose not satisfy the preset condition, determine at least one optimized design parameter by perform at least one round of update on the at least one initial design parameter in cooperation with an update module; in response to a determination that the second matching degree satisfies the preset condition, determining the at least one initial design parameter as the at least one optimized design parameter; converting the at least one optimized design parameter into a reference code using an encoder, obtaining a label corresponding to reference melt data from a first database in a memory, storing the reference code and the label in a second database in the memory, and the reference melt data being data of the glass melt corresponding to the at least one optimized design parameter; determining, based on user input, initial melt data of a glass melt to be processed and determining a target label from the first database; determining a target code based on the target label, converting the target code into at least one target design parameter using a decoder corresponding to the encoder; and growing a design simulation diagram corresponding to the at least one target design parameter based on the at least one target design parameter and a simulation instruction, and displaying the design simulation diagram via a user terminal; wherein the user input is obtained through the user terminal and includes at least one of the initial melt data or the simulation instruction.

One of the embodiments of the present disclosure provides a computer-readable storage medium, the storage medium storing computer instructions, and when a computer reads the computer instructions in the storage medium, the computer executes a method for designing a manufacturing and mixing system of a glass substrate.

### BRIEF DESCRIPTION OF THE DRAWINGS

The present disclosure will be further illustrated by way of exemplary embodiments, which are described in detail by means of the accompanying drawings. These embodiments are not limiting, and in these embodiments, the same numbering denotes the same structure, wherein:

FIG. 1 is a schematic diagram illustrating exemplary modules of a system for designing a manufacturing and mixing system of a glass substrate according to some embodiments of the present disclosure;

FIG. 2 is a flowchart illustrating an exemplary process for designing a manufacturing and mixing system of a glass substrate according to some embodiments of the present disclosure;

FIG. 3 is a schematic diagram illustrating an exemplary determination of at least one optimized design parameter according to some embodiments of the present disclosure;

FIG. 4 is a schematic diagram illustrating at least one round of update according to some embodiments of the present disclosure;

FIG. 5 is a schematic diagram illustrating an exemplary determination of at least one mixing parameter according to some embodiments of the present disclosure;

FIG. 6 is a schematic diagram illustrating an exemplary structure of a geometrical model of a mixing system according to some embodiments of the present disclosure;

FIG. 7 is a schematic diagram illustrating an exemplary cross-sectional design dimension of a mixing system according to some embodiments of the present disclosure; and

FIG. 8 is a schematic diagram illustrating an exemplary simulated mixing effect according to some embodiments of the present disclosure.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It will be understood that the terms “system,” “unit,” and/or “module” used herein are one method to distinguish different components, elements, parts, sections, or assemblies of different levels in ascending order. However, the terms may be displaced by other expressions if they may achieve the same purpose.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “include” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

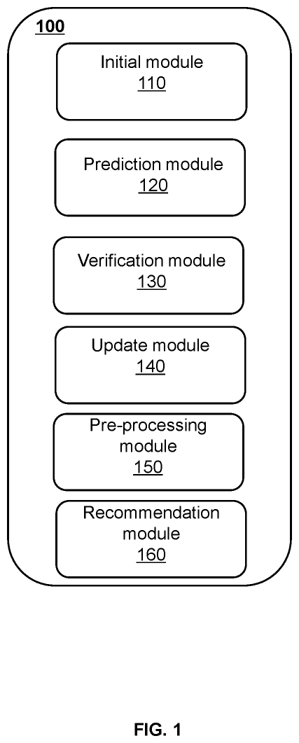

FIG. 1 is a schematic diagram illustrating exemplary modules of a system for designing a manufacturing and mixing system of a glass substrate according to some embodiments of the present disclosure.

In some embodiments, a system 100 for designing a manufacturing and mixing system of a glass substrate may include an initial module 110, a prediction module 120, a verification module 130, an update module 140, a pre-processing module 150 and a recommendation module 160.

The initial module may be a module configured to determine at least one initial design parameter. In some embodiments, the initial module may be configured to obtain at least one reference design parameter from a reference mixing system, establish an equivalence relationship based on a preset rule, and determine at least one initial design parameter of a mixing system based on the equivalence relationship.

The prediction module may be a module configured to predict a mixing effect. In some embodiments, the prediction module may be configured to predict a predicted mixing effect of an actual mixing system when processing a glass melt based on the at least one initial design parameter.

The mixing effect refers to a state of the glass melt after being processed by the mixing system. The mixing effect may characterize the quality of the glass substrate. The mixing effect may be characterized numerically.

In some embodiments, the prediction module may be further configured to determine the predicted mixing effect based on reference melt data and the at least one initial design parameter through a first prediction model.

A verification instruction may be an instruction that allows the verification module to start working.

The verification module may be a module used for the verification mixing effect. The verification module may, in response to receiving the verification instruction, initiate a verification action to determine a verification mixing effect of the at least one initial design parameter and determine a second matching degree between the verification mixing effect and a target mixing effect; in response to a determination that the second matching degree does not satisfy a preset condition, determine at least one optimized design parameter by performing at least one round of update on the at least one initial design parameter in cooperation with the update module; or in response to a determination that the second matching degree satisfies the preset condition, determine the at least one initial design parameter as the at least one optimized design parameter.

In some embodiments, the verification module may be further configured to determine the verification mixing effect based on first inspection data using a second prediction model.

In some embodiments, the verification module may be further configured to obtain at least one current mixing parameter and second inspection data corresponding to the at least one current mixing parameter; and in response to a determination that a fourth matching degree between an actual mixing effect corresponding to the second inspection data and the target mixing effect does not satisfy the preset condition, determining at least one updated mixing parameter through a parameter adjustment model.

In some embodiments, the verification module may also be communicatively connected to a test system. The test system may be used to perform test production of manufacturing and mixing the glass substrate and store historical test data as a reference to an end manufacturer for designing the mixing system.

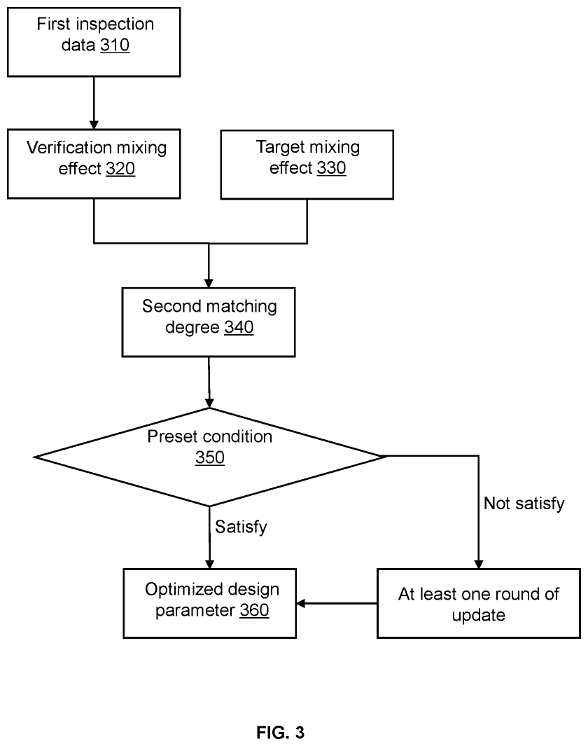

The test system may include a test terminal and an inspection device. The test terminal may be one or more terminal devices or software used for testing. The test terminal may be configured to send a test instruction to the verification module and receive a manufacturing instruction from the verification module. The inspection device may be a device configured to obtain various data from the test production. In some embodiments, the inspection device may be configured to collect the first inspection data when the actual mixing system processes the glass melt. More descriptions about the first inspection data can be found in FIG. 3 and the related descriptions thereof.

The update module may be a module configured to update the at least one initial design parameter. In some embodiments, the update module may determine at least one updated design parameter based on an update step length.

In some embodiments, the update step length may be determined based on a preset parameter range and an update round threshold.

The pre-processing module may be a module configured to preprocess the at least one optimized design parameter. In some embodiments, the pre-processing module may be configured to convert the at least one optimized design parameter into a reference code using an encoder, obtain a label corresponding to the reference melt data from a first database in a memory, store the reference code and the label in a second database in the memory, the reference melt data being data of a glass melt corresponding to the at least one optimized design parameter.

The recommendation module may be a module configured to determine a final design scheme. In some embodiments, the recommendation module may be configured to determine initial melt data of a glass melt to be processed based on a user input and determine a target label from the first database; determine a target code based on the target label and convert the target code into at least one target design parameter using a decoder corresponding to the encoder; generate a design simulation diagram corresponding to the at least one target design parameter based on the at least one target design parameter and a simulation instruction and display the design simulation diagram via a user terminal; wherein the user input may be obtained via the user terminal and may include at least one of the initial melt data or the simulation instruction.

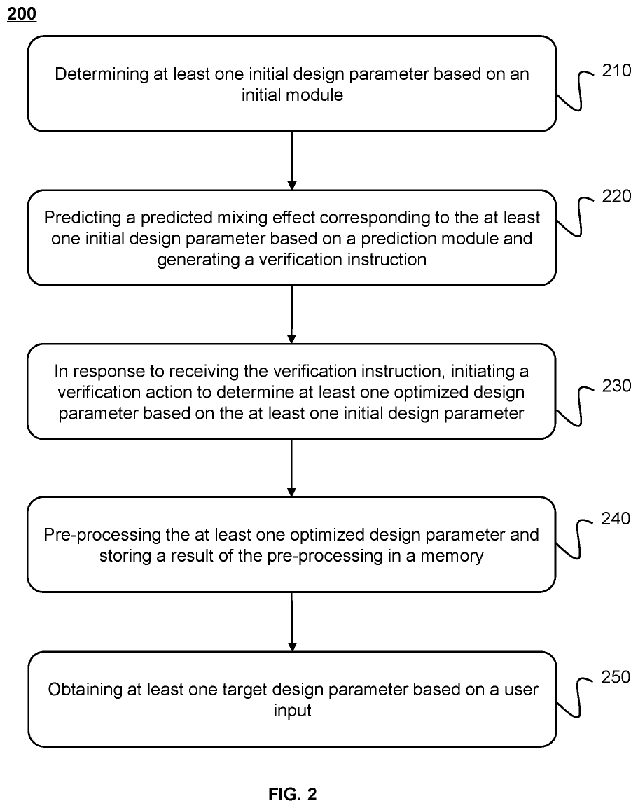

More descriptions about the system 100 for designing a manufacturing and mixing system of a glass substrate and functions thereof can be found in the related description in FIG. 2 to 5 of the present disclosure.

In some embodiments, various modules of the system 100 for designing a manufacturing and mixing system of a glass substrate may be integrated in a processor.

It is to be noted that the above description of the system for designing a manufacturing and mixing system of a glass substrate and its modules is provided only for descriptive convenience, and does not limit the present disclosure to the scope of the cited embodiments. It is to be understood that for a person skilled in the art, with an understanding of the principle of the system, it may be possible to arbitrarily combine modules or form subsystems that are connected to other modules without departing from this principle.

FIG. 2 is a flowchart illustrating an exemplary process for designing a manufacturing and mixing system of a glass substrate according to some embodiments of the present disclosure. As shown in FIG. 2, a process 200 includes following operations. In some embodiments, the process 200 may be executed by a processor of the system 100 for designing a manufacturing and mixing system of a glass substrate.

In 210, at least one initial design parameter may be determined based on an initial module.

In some embodiments, the processor may obtain at least one reference design parameter from a reference mixing system based on the initial module, establish an equivalence relationship based on a preset rule, and determine at least one an initial design parameter of an actual mixing system based on the equivalence relationship.

The reference mixing system refers to a preset mixing system, and at least one design parameter corresponding to the reference mixing system may be the at least one reference design parameter.

In some embodiments, the reference mixing system may be determined based on at least one standard mixing system in a standard system database. At least one design parameter corresponding to the standard mixing system may be a standard value manually predetermined.

The actual mixing system may be a mixing system that is actually used for manufacturing.

The at least one initial design parameter refers to at least one preliminary determined design parameter of the actual mixing system. In some embodiments, the at least one initial design parameter may be determined based on the equivalence relationship.

The equivalence relationship refers to a relationship in which the reference mixing system and the actual mixing system are approximately equal. In some embodiments, the equivalence relationship may include a mechanical equivalence relationship and an effect equivalence relationship. The mechanical equivalence relationship refers to a relationship where shear stresses are approximately the same when the mixing is performed between the reference mixing system and the actual mixing system, and the effect equivalence relationship refers to a relationship where mixing correlations are approximately the same between the reference mixing system and the actual mixing system. In some embodiments, the mechanical equivalence relationship may also be referred to as a shear stress equivalence relationship. In some embodiments, the effect equivalence relationship may also be referred to as a mixing effect equivalence relationship.

In some embodiments, the mechanical equivalence relationship and the effect equivalence relationship may be determined based on a preset rule.

The preset rule may be a criteria and rule on which the establishment of the equivalence relationship relies, and the preset rule may be preset manually. In some embodiments, the preset rule may include that the shear stresses and mixing effects of the reference mixing system and the actual mixing system when the mixing is performed may be regarded as the same.

Through the preset rule, the mechanical equivalence relationship and the effect equivalence relationship may be expressed by an equation, respectively, and based on the two equivalence relationships, the at least one initial design parameter of the actual mixing system may be determined.

In some embodiments, the standard mixing system may be selected as the reference mixing system, and at least one reference design parameter corresponding to the reference mixing system may be obtained, wherein the at least one reference design parameter may include at least one of a reference swept height of a blade, a reference pull amount, a reference inner diameter of a mixing tank, a reference blade diameter, a reference power, a reference rotation speed, or a reference torque;

The mechanical equivalence relationship may be established based on the reference inner diameter of the mixing tank, the reference blade diameter, and the reference rotation speed;

The effect equivalence relationship may be established based on the reference swept height of the blade, the reference pull amount, the reference blade diameter, the reference power, the reference speed, and the reference torque;

According to the at least one reference design parameter, the mechanical equivalence relationship, and the effect equivalence relationship, the at least one initial design parameter of the actual mixing system may be determined to complete the design of the actual mixing system. The at least one initial design parameter may include at least one of an inner diameter of an actual mixing tank, an actual blade diameter, or an actual swept height of a blade.

In some situations, the reference swept height may also be referred to as a swept height of a blade of a mixer, the reference pull amount may also be referred to as a pull amount, the reference inner diameter of the mixing tank may be referred to as an inner diameter of the mixing tank, the reference blade diameter may also be referred to as a blade diameter, the reference power may be also be referred to as a power of the mixer, the reference rotation speed may also be referred to as a rotation speed of the mixer, the reference torque may also be referred to as a torque of the mixer, the actual blade diameter may also be referred to as a blade diameter of an actual mixer, and the actual swept height of the blade may also be referred to as a swept height of a blade of the actual mixer.

In some embodiments, an equation of the shear stress equivalence relationship may be:

$$\frac{N \cdot {D}_{Y}}{{D}_{B} - {D}_{Y}} = \frac{{N}_{0} \cdot {D}_{Y 0}}{{D}_{B 0} - {D}_{Y 0}} ,$$

where N denotes the actual rotation speed, D_{Y} denotes the actual blade diameter, D_{B} denotes the inner diameter of the actual mixing tank, N₀ denotes the reference rotation speed, D_{Y0} denotes the reference blade diameter, and D_{B0} denotes the reference inner diameter of the mixing tank.

In some embodiments, a shear stress T of the shear stress equivalence relationship may satisfy a following relationship:

$$\vert τ \vert ∝ η \times \frac{π \cdot N \cdot {D}_{Y}}{C} ,$$

where η denotes a viscosity of a glass, and C denotes a gap between a blade of the mixer and an inner wall of the mixing tank.

The gap C between the blade of the mixer and the inner wall of the mixing tank may satisfy a following relationship:

$$C = \frac{{D}_{B} - {D}_{Y}}{2} ,$$

In some embodiments, an equation of the mixing effect equivalence relationship may be:

$$\frac{N \cdot T \cdot {D}_{Y}^{2} \cdot H}{{Q}^{2}} = \frac{{N}_{0} \cdot {T}_{0} \cdot {D}_{Y 0}^{2} \cdot {H}_{0}}{{Q}_{0}^{2}}$$

$$or \frac{P \cdot {D}_{Y}^{2} \cdot H}{{Q}^{2}} = \frac{{P}_{0} \cdot {D}_{Y 0}^{2} \cdot {H}_{0}}{{Q}_{0}^{2}} .$$

where T denotes an actual torque, P denotes an actual power, H denotes the actual swept height of the blade, Q denotes the actual pull amount, T₀ denotes the reference torque, P₀ denotes the reference power, H₀ denotes the reference swept height of the blade, and Q₀ denotes the reference pull amount.

In some situations, the actual torque may also be referred to as a torque of the actual mixer, and the actual power may be referred to as a power of the actual mixer.

In some embodiments, a mixing effect E of the mixing effect equivalence relation may satisfy a following relationship:

$$E ∝ \sqrt{\frac{C \cdot \vert τ \vert \cdot T \cdot {D}_{Y} \cdot H}{η}} .$$

An equation for calculating the swept height H of the blade of the actual mixer may be:

$$1 \leq \frac{H}{{H}_{0}} \leq 1.2 .$$

An equation for calculating the blade diameter D_{Y} of the actual mixer may be:

$$\frac{{D}_{Y}}{{D}_{Y 0}} = \frac{Q}{{Q}_{0}} \sqrt{\frac{{P}_{0}}{P} \times \frac{{H}_{0}}{H}} = \frac{Q}{{Q}_{0}} \sqrt{\frac{{N}_{0}}{N} \times \frac{{T}_{0}}{T} \times \frac{{H}_{0}}{H}} .$$

An equation for calculating the inner diameter D_{B} of the actual mixing tank may be

$${D}_{B} = {D}_{Y} + ( {D}_{B 0} - {D}_{Y 0} ) \times \frac{N}{{N}_{0}} \times \frac{{D}_{Y}}{{D}_{Y 0}} .$$

In 220, a predicted mixing effect corresponding to the at least one initial design parameter may be predicted based on a prediction module and a verification instruction may be generated.

In some embodiments, the processor may predict a predicted mixing effect of the actual mixing system when the glass melt is processed based on the at least one initial design parameter using the prediction module, and in response to a determination that a first matching degree between the predicted mixing effect and a target mixing effect degree satisfies a preset condition, generate the verification instruction and sending the verification instruction to a verification module.

The predicted mixing effect refers to a predicted mixing effect of the actual mixing system. In some embodiments, the predicted mixing effect may be expressed as a numerical value, e.g., 1-10, and larger values characterize better mixing effects.

In some embodiments, the processor may determine the predicted mixing effect of the actual mixing system in a variety of ways via the prediction module.

In some embodiments, the prediction module may determine the predicted mixing effect based on reference melt data and the at least one initial design parameter through a first prediction model.

The reference melt data may be data related to a glass melt used for mixing in the reference mixing system. The reference melt data may include a composition of a mating material, an initial temperature, a density, and a viscosity. The composition of the mating material refers to a composition of ingredients in the glass melt, which may include quartz sand, feldspar, borax, limestone, soda ash, and so on.

In some embodiments, there are differences in glass melts used for different manufacturing purposes, and thus, the prediction module may determine the reference melt data from at least one set of standard melt data. The standard melt data and material data of glass melts corresponding to different manufacturing purposes may be determined based on relevant manufacturing standards and/or experience. The manufacturing purpose may include the quality of a glass substrate planned to be produced.

In some embodiments, the reference melt data may be represented as a composition feature vector. The composition feature vector of the reference melt data may characterize the reference melt data, and may include elements such as the composition of the mating material, the initial temperature, the density, the viscosity, etc. For example, the reference melt data (a1, a2, . . . , an, b, c, d) may indicate that in the glass melt, a content of a major composition 1 is a1, a content of a major composition 2 is a2, a content of a major composition n is an, the initial temperature is b, the density is c, and the viscosity is d.

In some embodiments, the prediction module may determine the reference melt data based on a first preset table. The first preset table may include qualities corresponding to glass substrates of different manufacturing purposes and reference melt data corresponding to the glass substrates of different manufacturing purposes. The first preset table may be constructed based on historical data.

The first prediction model may be a model configured to determine the predicted mixing effect and may be a machine learning model. In some embodiments, the first prediction model may be a Convolutional Neural Networks (CNN) model, a Deep Neural Networks (DNN) model, or any models that may realize the same or similar functions.

In some embodiments, an input to the first prediction model may include the reference melt data and the at least one initial design parameter, and an output may include the predicted mixing effect. More details about the at least one initial design parameter can be found in Operation 210 and the related descriptions thereof.

In some embodiments, the processor may train the first prediction model based on a large number of first samples with a first label. Each of the first samples may include sample reference melt data and at least one sample initial design parameter. The first label may be a sample mixing effect corresponding to the first sample. The first sample and the first label may be obtained based on the historical data.

In some embodiments, the sample mixing effect may be determined based on the quality of a historical glass substrate manufactured in a historical manufacturing operation in accordance with the sample reference melt data and the at least one sample initial design parameter. The better the quality of the historical glass substrate, the better the mixing effect. In some embodiments, the prediction module may construct a historical feature vector based on the historical glass substrate, and determine the mixing effect by determining a similarity between the historical feature vector and a standard reference vector corresponding to a standard glass substrate.

The standard glass substrate may be a historically manufactured glass substrate that satisfies a preset evaluation standard. In some embodiments, the preset evaluation standard may include a least amount of impurities, a most uniform thickness, and/or a highest light transmittance among historically manufactured glass substrates. The preset evaluation standard may also be determined manually or based on existing preset evaluation templates for glass substrate quality.

In some embodiments, the prediction module may construct a quality feature vector based on at least one basic parameter of the glass substrate, and determine a similarity between the quality feature vector and a quality reference vector to determine the mixing effect.

The at least one basic parameter may be at least one parameter related to the quality of the glass substrate. The at least one basic parameter may include at least a count of impurities, a thickness extreme, and a light transmittance. The impurities may include particles, bubbles, stripes, or the like. The thickness extreme may be a difference between a maximum value and a minimum value of a thickness of the substrate, which may be determined based on manual measurement. The quality of the glass substrate may be inversely correlated with the count of impurities and the thickness extreme, respectively, and be positively correlated with the light transmission.

In some embodiments, the processor may construct the quality feature vector based on the at least one basic parameter of the glass substrate. For example, a quality feature vector Q (q₁, q₂, q₃, q₄, q₅) may indicate that a count of particles of the glass substrate is q₁, a count of bubbles is q₂, a count of stripes is q₃, a thickness extreme is q₄, a light transmittance is q₅.

In some embodiments, the processor may construct a standard quality vector based on at least one basic parameter of the standard glass substrate. A manner in which the quality reference vector is constructed can be seen in a manner in which the quality feature vector is constructed.

In some embodiments, the processor may determine a similarity between the quality feature vector and the standard quality vector to obtain the mixing effect. The mixing effect may be positively correlated with the similarity.

In some embodiments, the mixing effect may be determined by the similarity between the quality feature vector and the standard quality vector, the similarity is correlated with a distance between the quality feature vector and the standard quality vector, and the similarity is negatively correlated with the distance between the quality feature vector and the standard quality vector. The mixing effect may be expressed by a times a value corresponding to the vector distance between the quality feature vector and the quality reference vector. α may be a coefficient less than 0, which may be based on a manual predetermination.

In some embodiments, the prediction module may construct an image feature vector based on an image of the glass substrate through a quality judgment model.

The quality judgment model may be a model configured to determine the image feature vector and a quality judgment result of the glass substrate, including an image feature extraction layer and a quality judgment layer. The quality judgment model may be a machine learning model. For example, the image feature extraction layer may be a convolutional neural networks (CNN) model, and the quality judgment layer may be a Neural Networks (NN) model.

In some embodiments, an input to the image feature extraction layer may include the image of the glass substrate and an output may include the image feature vector. An input to the quality judgment layer may include the image feature vector outputted by the image feature extraction layer and an output may include the quality judgment result.

In some embodiments, the prediction module may train the quality judgment model based on a large number of second samples with a second label. The second samples may include a plurality of historical images of a sample glass substrate. The second label may be a sample quality judgment result corresponding to the second samples, which may be obtained based on the historical data.

In some embodiments, the processor may input images of a sample glass substrate to the image feature extraction layer to obtain the image feature vector output by the image feature extraction layer, input the image feature vector to the quality judgement layer to obtain the quality judgement result output by the quality judgement layer. A loss function may be constructed based on a sample quality judgement result and the quality judgement result output by the quality judgement layer, and parameters of the image feature extraction layer and the quality judgement layer may be updated simultaneously. By updating the parameters, a trained image feature extraction layer and a trained quality judgement layer may be obtained.

In some embodiments, the prediction model may determine the quality feature vector based on the image feature vector output by the image feature extraction layer, determine a distance between the quality feature vector and the standard quality vector corresponding to the standard glass substrate, and determine the mixing effect. A manner in which the standard quality vector is constructed and a manner in which the mixing effect is determined based on the vector distance can be found in the above-mentioned descriptions thereof.

Some embodiments of the present disclosure predict the mixing effect based on the reference melt data and the reference design parameter, which can screen out at least one initial design parameter corresponding to a mixing effect which is likely to satisfy a requirement, and further verify the at least one initial design parameter, so as to improve the efficiency of determining the parameter and avoid unnecessary work.

In some embodiments, in response to the first matching degree between the predicted mixing effect and the target mixing effect satisfying the preset condition, the verification instruction may be generated and sent to the verification module.

The target mixing effect may be a mixing effect expected to be achieved by the actual mixing system. In some embodiments, the target mixing effect may be determined based on actual requirements, or based on a requirement for a mixing effect corresponding to the standard glass substrate.

The first matching degree may be a matching degree between the predicted mixing effect and the target mixing effect. The higher the first matching degree, the closer the predicted mixing effect is to the target mixing effect. The preset condition may include a condition that needs to be satisfied by a relationship between the predicted mixing effect and the target mixing effect. The preset condition may include the predicted mixing effect being not less than the target mixing effect, or a ratio of the predicted mixing effect to the target mixing effect being greater than a ratio threshold, etc.

In some embodiments, the first matching degree may be a difference between the predicted mixing effect and the target mixing effect. If the difference greater than a difference threshold, the mixing effect may be better, with the difference being positively correlated with the mixing effect. The difference threshold may be preset manually. For example, when the difference threshold is 0, i.e., when the predicted mixing effect is greater than the target mixing effect, the mixing effect may be indicated to be better.

In some embodiments, the first matching degree may be a ratio of the predicted mixing effect to the target mixing effect. When the ratio is greater than the ratio threshold, it may indicate a better mixing effect, and the ratio is positively correlated with the mixing effect. The ratio threshold may be preset manually. For example, when the ratio threshold is 0.6 and a ratio of a currently predicted mixing effect to the target mixing effect is 0.9, it may indicate that the mixing effect is better and the currently predicted mixing effect is at a level of 90% of the target mixing effect.

In response to a determination that the first matching degree satisfies the preset condition, the prediction module may generate the verification instruction and send the verification instruction to the verification module. In response to a determination that the first matching degree does not satisfy the preset condition, the prediction module may send a reminder to an operator to remind the operator to replace a parameter such as the reference design parameter.

In 230, in response to receiving the verification instruction, a verification action may be initiated to determine the at least one optimized design parameter based on the at least one initial design parameter.

In some embodiments, in response to receiving the verification instruction, the processor may initiate the verification action via the verification module to determine a verification mixing effect of the at least one initial design parameter, and determine a second matching degree between the verification mixing effect and the target mixing effect.

The verification mixing effect refers to an actual mixing effect of the actual mixing system designed based on the at least one initial design parameter.

In some embodiments, the verification mixing effect may be determined based on a mixing situation of a reference glass melt in an actual mixing system in an external test system.

In some embodiments, the verification action may include sending a manufacturing instruction to the test terminal, in response to receiving the test instruction, collecting first detection data when the actual mixing system processes the glass melt through the inspection device of the external test system in real-time, and determining the verification mixing effect based on the first inspection data.

The second matching degree refers to a matching degree between the verification mixing effect and the target mixing effect.

In some embodiments, the second matching degree may be determined based on the verification mixing effect and the target mixing effect. A manner of determining the second matching degree is similar to the manner of determining the first matching degree, which can be referred to in operation 220.

In some embodiments, in response to a determination that the second matching degree does not satisfy the preset condition, the processor may determine the at least one optimized design parameter by performing at least one round of update on the at least one initial design parameter through the verification module in cooperation with the update module.

In some embodiments, in response to a determination that the second matching degree satisfies the preset condition, the processor may determine the at least one initial design parameter as the at least one optimized design parameter via the verification module.

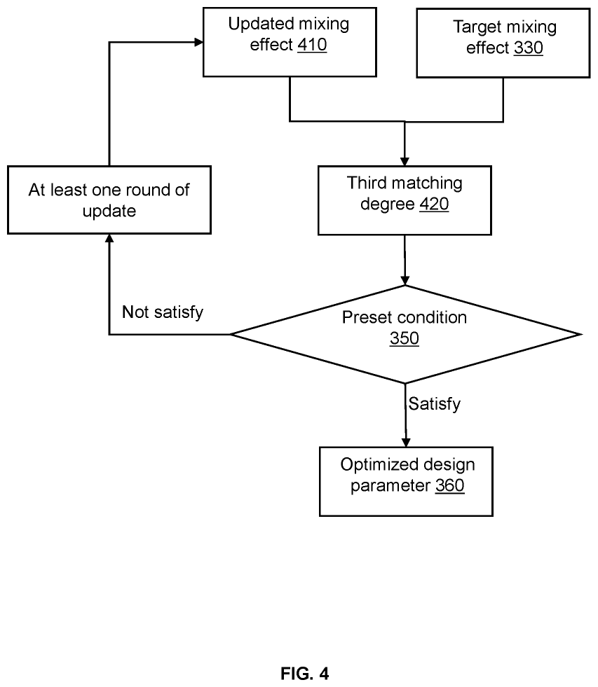

More details about the verification action, determination of the verification mixing effect, and at least one round of update can be found in FIG. 3 and FIG. 4 of the present disclosure and the associated descriptions thereof.

In 240, the at least one optimized design parameter may be pre-processed and a result of the pre-processing may be stored in the memory.

In some embodiments, the processor may, based on a pre-processing module, convert the at least one optimized design parameter into a reference code via an encoder, obtain a label corresponding to reference melt data from a first database in a memory, and store the reference code and a label in a second database in the memory.

The reference melt data may be data of a glass melt corresponding to the at least one optimized design parameter.

The reference code may be a number or symbol used to characterize the at least one optimized design parameter.

In some embodiments, the pre-processing module may convert the at least one optimized design parameter into the reference code via a variety of encoders, e.g., a Base64 encoding algorithm, a Huffman encoding algorithm, etc.

The label refers to a number or symbol used to characterize the reference melt data.

In some embodiments, the pre-processing module may obtain the label corresponding to the reference melt data from the first database in the memory. The first database may be used to store the reference melt data and the label corresponding to the reference melt data. The first database may be constructed based on historical manufacturing data. The label may be labeled in a variety of forms, e.g., numeric, symbolic, etc.

In some embodiments, the pre-processing module may store the reference code and the label in the second database of the memory.

In 250, at least one target design parameter may be obtained based on a user input.

In some embodiments, the processor may determine, via a recommendation module, initial melt data of a glass melt to be processed based on the user input and determine a target label from the first database; and determine a target code based on the target label and convert the target code into the at least one target design parameter by using a decoder corresponding to the encoder.

The initial melt data may be data related to an actual glass melt to be mixed. In some embodiments, the initial melt data may be determined based on the user input.

The target label may be a data label corresponding to the initial melt data. In some embodiments, the recommendation module may construct a reference vector based on the reference melt data, and the reference vector may characterize the reference melt data. Elements of the reference vector may include a composition of a mating material, an initial temperature, a density, and a viscosity. The recommendation module may also construct a feature vector based on the initial melt data. More details about a construction manner of the feature vector can be referred to a construction manner of the reference vector. The recommendation module may calculate a spatial distance between a plurality of reference vectors and feature vectors, and determine reference melt data corresponding to a reference vector with a smallest spatial distance from the feature vector as target melt data.

In some embodiments, the recommendation module may query the first database and use a label corresponding to the target melt data as the target label.

The target code may be a code corresponding to the target label. In some embodiments, the recommendation module may, based on the target label, query the second database and use an encoding label corresponding to the target label as the target code.

In some embodiments, the recommendation module may convert the target code to the at least one target design parameter using a decoder corresponding to the encoder. In some embodiments, the decoder may convert the target code to the at least one target design parameter in multiple ways. For example, the decoder may convert the target code to the at least one target design parameter via algorithms such as Base64 decoding algorithms, Huffman decoding algorithms, or the like.

The at least one target design parameter may be at least one design parameter of the actual mixing system.

In some embodiments, the processor may also generate a design simulation diagram corresponding to the at least one target design parameter based on the at least one target design parameter and a simulation instruction, and display the design simulation diagram via a user terminal.

The simulation instruction may be an instruction that generates the design simulation diagram. The simulation instruction may be determined based on the user input.

The design simulation diagram may be a picture or modeling model of a mixing vessel generated based on the at least one target design parameter.

In some embodiments of the present disclosure, the at least one initial design parameter of the actual mixing system may be obtained based on the equivalence relationship, and the at least one initial design parameter may be updated through the verification module and the update module to obtain the at least one target design parameter, which enables a more intelligent and efficient design of the mixing system to better meet the design requirement of the mixing system.

It should be noted that the foregoing description of the process 200 is intended to be exemplary and illustrative only, and does not limit the scope of application of the present disclosure. For a person skilled in the art, various corrections and changes can be made to the process 200 under the guidance of the present disclosure. However, these corrections and changes remain within the scope of the present disclosure.

FIG. 3 is a schematic diagram illustrating an exemplary determination of at least one optimized design parameter according to some embodiments of the present disclosure.

In some embodiments, a verification module may, in response to receiving a verification instruction, initiate a verification action to determine a verification mixing effect 320 of at least one initial design parameter, determine a second matching degree 340 between the verification mixing effect 320 and a target mixing effect 330; in response to a determination that the second matching degree 340 does not satisfy a preset condition 350, determine at least one optimized design parameter 360 by performing at least one round of update on the at least one initial design parameter in cooperation with an update module; and in response to a determination that the second matching degree satisfies the preset condition 350, determine the at least one initial design parameter as the at least one optimized design parameter 360.

More descriptions of the target mixing effect can be found in FIG. 2 and the related descriptions thereof. More descriptions of the verification mixing effect, the second matching degree, and the preset condition can be found in FIG. 2 and the related descriptions thereof.

In some embodiments, the verification action may include sending a manufacturing instruction to a test terminal, and in response to receiving a test instruction, collecting first inspection data 310 when an actual mixing system processes a glass melt in real-time via an inspection device; and determining the verification mixing effect 320 based on the first inspection data 310. More descriptions of the test terminal, the inspection device, the manufacturing instruction, and the test instruction may be found in FIG. 1 and the related descriptions thereof.

The first inspection data may be actual data of a glass melt used for verification. The first inspection data may include temperatures, densities, images, etc., of a plurality of locations of the glass melt.

In some embodiments, the verification module may obtain the first inspection data via an external test system. The inspection device may obtain the first inspection data of the glass melt in real-time.

The processor may determine the verification mixing effect in various ways.

In some embodiments, the verification module may determine the verification mixing effect 320 by querying a third preset table based on the first inspection data 310. The third preset table may include a correspondence between historical first inspection data and a historical verification mixing effect corresponding to the historical first inspection data. The third preset table may be constructed based on historical data.

In some embodiments, the verification module may be configured to determine, based on the first inspection data 310, the verification mixing effect 320 via a second prediction model.

The second prediction model may be a model configured to determine the verification mixing effect. In some embodiments, the second prediction model may be a machine learning model.

In some embodiments, the second prediction model may include a feature extraction layer and an effect determination layer. The feature extraction layer may be a Convolutional Neural Networks (CNN) model and the effect determination model may be a Neural Networks (NN) model. An input to the feature extraction layer may include the first inspection data and an output may include a first inspection feature. An input to the effect determination layer may include the first inspection feature output by the feature extraction layer and an output may include the verification mixing effect. The first inspection feature may characterize a feature of the first inspection data. For example, the first inspection feature may characterize features of temperatures, densities, and images of a plurality of locations of a glass melt in the first inspection data.

In some embodiments, the feature extraction layer and the effect determination layer may be obtained by joint training based on a large number of third samples with a third label. A process of the joint training is similar to that of the prediction model, which can be referred to FIG. 2 and the related descriptions thereof.

In some embodiments, the third sample may include sample first inspection data of a sample glass melt. The third label may be a sample mixing effect corresponding to the third sample in the historical data. The third sample and the third label may be obtained based on the historical data. More descriptions of the sample mixing effect can be found in FIG. 2 and the related descriptions thereof.

Some embodiments of the present disclosure determine the verification mixing effect by the second prediction model and verify whether the predicted mixing effect satisfies an expectation, and if the predicted mixing effect satisfies the expectation, then a downstream production proceeds, which can avoid the low-quality production and improve the productivity of a factory.

In some embodiments, in response to a determination that the second matching degree 340 does not satisfy the preset condition 350, the verification module may perform at least one round of update on the at least one initial design parameter in cooperation with the update module to determine the at least one optimized design parameter 360. More descriptions of the update can be found in FIG. 4 and the related descriptions thereof.

The at least one optimized design parameter may be at least one design parameter that has been optimized for use in an actual manufacturing and mixing system.

In some embodiments, in response to a determination that the second matching degree 340 satisfies the preset condition 350, the processor may determine the at least one initial design parameter as the at least one optimized design parameter 360.

FIG. 4 is a schematic diagram illustrating at least one round of update according to some embodiments of the present disclosure.

In some embodiments, a verification module may perform a verification action to determine an updated mixing effect 410 in response to a verification instruction.

In some embodiments, the verification instruction may further include determining at least one updated design parameter. The verification instruction may control an update module to perform the verification action to determine an updated mixing effect corresponding to the at least one updated design parameter.

The updated mixing effect may be a mixing effect corresponding to a design parameter after at least one round of update is performed. The updated mixing effect is determined in a similar manner as the verification mixing effect and may be determined by a second prediction model. An input to the second prediction model may include updated mixing data corresponding to the updated mixing effect and an output may include the updated mixing effect 410.

More details about the second prediction model can be found in the related description in FIG. 3.

The at least one updated design parameter refers to at least one design parameter after at least one round of update is performed. The at least one updated design parameter may include updating three dimensions including an inner diameter of a mixing tank, a diameter of a blade of a mixer, and a swept height of the blade of the mixer. In some embodiments, the update module may determine the at least one updated design parameter based on an update step length.

The update step length may be an amount by which the design parameter changes with each round of update. Different design parameters and preset parameter ranges corresponding to the different design parameters may correspond to different update step lengths. In some embodiments, the update step length may be set manually.

In some embodiments, the update step length may be determined based on a preset parameter range and an update round threshold.

The preset parameter range may be a change range of the design parameter. In some embodiments, the preset parameter range may include an adjustment range corresponding to the inner diameter of the mixing tank, the diameter of the blade of the mixer, and the swept height of the blade of the mixer, respectively.

In some embodiments, the preset parameter range may be set manually. For example, when an inner diameter of a mixing tank in an initial design parameter is 100 mm, a preset parameter range corresponding to the inner diameter of the mixing tank may be 90 mm-110 mm.

The update round threshold may be a maximum count of rounds of update performed. For example, the update round threshold may be 10, 20, etc. In some embodiments, the update round threshold may be determined based on historical experience and/or an actual need.

In some embodiments, the update step length may be positively correlated with a range length of the preset parameter range and negatively correlated with the update round threshold. For example, the update step length may be determined based on the range length of the preset parameter range and the update round threshold by a following equation (1):

$$l = ( {R}_{max} - {R}_{min} ) / α , \qquad ( 1 )$$

where l denotes the update step length; (Rₘₐₓ-Rₘᵢₙ) denotes the range length of the preset parameter range, which may be a difference between a maximum value Rₘₐₓ of the preset parameter range and a minimum value Rₘᵢₙ of the preset parameter range; and a denotes the update round threshold.

Some embodiments of the present disclosure determine the update step length based on the preset parameter range and the update round threshold, which can comprehensively consider a relationship between a change range of different parameters and a maximum count of rounds of update, determine a more adaptive update step length, improve the fineness of each round of update, and obtain at least one more accurate optimized design parameter.

In some embodiments, in response to a determination that a third matching degree 420 between the updated mixing effect 410 and the target mixing effect 330 does not satisfy the preset condition 350, the processor may determine an update instruction and send the update instruction to the update module to perform a next round of update. The update instruction may control the update module to update the at least one design parameter, and determine at least one new updated design parameter and a new updated mixing effect.

The third matching degree may be a matching degree between the updated mixing effect and the target mixing effect. More details about the target mixing effect and the preset condition can be found in FIG. 2 and the related descriptions thereof.

In some embodiments, the third matching degree may be determined based on the updated mixing effect 410 and the target mixing effect 330. A manner of determining the third matching degree is similar to that of the first matching degree, which can be referred to Operation 220 and the related descriptions thereof.

In some embodiments, in response to a determination that the third matching degree 420 between the updated mixing effect 410 and the target mixing effect 330 satisfies the preset condition 350, the processor may generate an abort instruction and send the abort instruction to the update module to stop the update. The abort instruction may control the update module to stop the update. The processor may determine at least one currently updated design parameter as the at least one optimized design parameter 360. More details about the at least one optimized design parameter can be found in FIG. 3 and the related descriptions thereof.

In some embodiments, in response to a determination that the third matching degree still does not satisfy the preset condition when the update round threshold has been reached, an alert is sent to an operator, reminding the operator to replace at least one reference design parameter and re-determine the at least one initial design parameter. For example, the operator may replace a reference mixing system, and based on at least one reference design parameter corresponding to a new reference mixing system, establish an equivalence relationship based on a preset rule through an initial module, and determine at least one new initial design parameter of the mixing system based on an equivalence relationship.

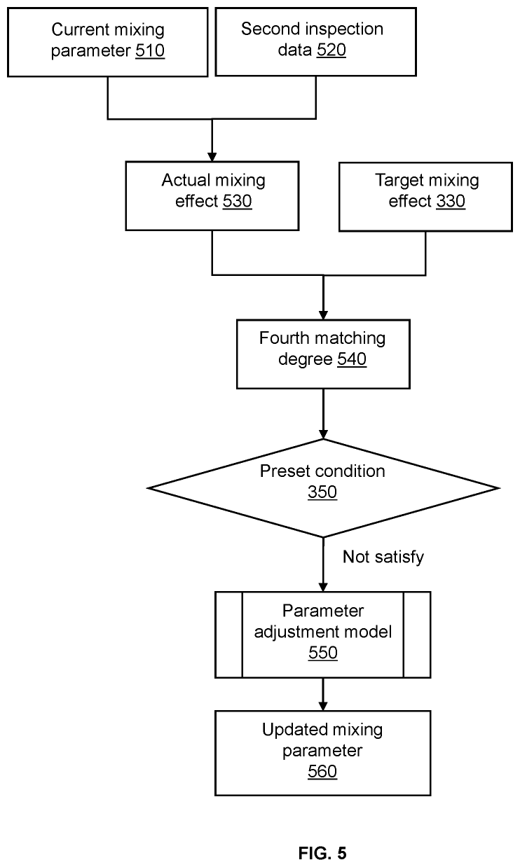

FIG. 5 is a schematic diagram illustrating an exemplary determination of at least one mixing parameter according to some embodiments of the present disclosure. A process for determining the mixing parameter as shown in FIG. 5 may include the following.

When a verification module is testing at least one initial design parameter and at least one updated design parameter, it is common to use at least one uniform mixing parameter to easily observe a mixing capability at different design parameters. However, after determining at least one optimized design parameter, there is randomness in a mixing process when a mixing operation is performed based on the at least one optimized design parameter, and therefore, in order to optimize a mixing effect of an actual mixing system, it is necessary to determine whether at least one current mixing parameter satisfies a manufacturing requirement and update the at least one current mixing parameter when the at least one current mixing parameter fails to satisfy the manufacturing requirement.

In some embodiments, a processor may obtain the at least one current mixing parameter 510 and second inspection data 520 corresponding to the at least one current mixing parameter via the verification module; in response to a determination that a fourth matching degree 540 between an actual mixing effect 530 corresponding to the second inspection data and the target mixing effect 330 does not satisfy the preset condition 350, determine the at least one updated mixing parameter 560 using a parameter adjustment model 550.

The at least one current mixing parameter refers to at least one mixing parameter used currently.

In some embodiments, the at least one current mixing parameter 510 may be obtained in a variety of ways. For example, the at least one current mixing parameter may be a pre-set reference mixing parameter, or a commonly used mixing parameter determined based on actual manufacturing experience, or the like.

The second inspection data refers to data corresponding to a glass melt after mixing is completed. The second inspection parameter may include a plurality of temperatures, densities, and images of the glass melt after mixing.

In some embodiments, the second inspection data 520 may be obtained by at least one sensor set up in an external test system.

In some embodiments, the verification module may communicate with at least one sensor in the external test system to obtain the second inspection data in accordance with a predetermined data obtaining cycle. The data obtaining cycle may be determined based on manufacturing experience and/or an actual need, for example, the data obtaining cycle may be every 30 minutes, etc.

The fourth matching degree refers to a matching degree between the actual mixing effect and the target mixing effect. The higher the fourth matching degree, the better the actual mixing effect, and the better the mixing requirement may be satisfied.

In some embodiments, the actual mixing effect may be determined based on a second prediction model. At this point, an input to the second prediction model may be the second inspection data and an output may be the actual mixing effect. More details about the second prediction model can be found in the related description in FIG. 2.

In some embodiments, the fourth matching degree 540 may be determined based on the actual mixing effect and the target mixing effect. A manner of determining the fourth matching degree is similar to that of the first matching degree, which can be referred to Operation 220 and the related descriptions thereof.

In some embodiments, the processor may determine the at least one updated mixing parameter 560 via the parameter adjustment model 550. An input to the parameter adjustment model 550 may include the at least one current mixing parameter and the second inspection data, and an output may include the at least one updated mixing parameter.

In some embodiments, the parameter adjustment model may be a machine learning model. In some embodiments, the parameter adjustment model may be a Convolutional Neural Networks (CNN) model, a Deep Neural Networks (DNN) model, or another model that may perform a same or corresponding function.

In some embodiments, the parameter adjustment model may be obtained by training based on a large number of third samples with a third label in a gradient descent manner or other feasible manners. In which the third label and the third samples may be obtained based on historical data. The third sample may include historical inspection data corresponding to a historical mixing parameter machine, and the third label may include a historical target adjustment parameter corresponding to the third sample.

In some embodiments, each set of the third samples may correspond to a plurality of historical adjustment parameters, and the plurality of historical adjustment parameters may be screened based on a preset filtering rule, and a historical adjustment parameter that has a best mixing effect after adjustment may be used as the historical target adjustment parameter.

In some embodiments, the processor may determine an adjustment instruction based on the at least one updated mixing parameter and send the adjustment instruction to the actual mixing system via the verification module, and adjust the at least one current mixing parameter of the actual mixing system to the at least one updated mixing parameter to perform mixing. The foregoing adjustment instruction is used to instruct the actual mixing system to adjust the mixing parameter, which may include the updated mixing parameter.

In some embodiments of the present disclosure, it is possible to determine, based on the at least one optimized design parameter, the actual mixing effect of the actual mixing system under the current mixing parameter, and to adjust the mixing parameter of the actual mixing system based on the actual mixing effect, which can more intelligently adapt the mixing parameter based on an actual mixing situation and is conducive to obtaining a better mixing effect.

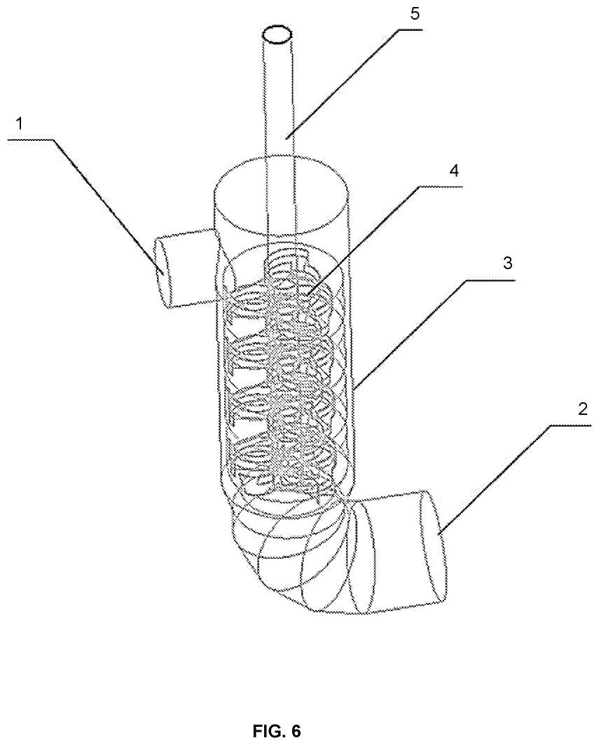

FIG. 6 is a schematic diagram illustrating an exemplary structure of a geometrical model of a mixing system according to some embodiments of the present disclosure.

As shown in FIG. 6, the mixing system may include an inlet end 1, an outlet end 2, a mixing tank 3, a mixing shaft 5, and a plurality of mixing blades 4; the mixing tank 3 may be a cylindrical cavity, with the inlet end 1 being provided at an upper part of a sidewall of the mixing tank 3; the outlet end 2 is provided at a bottom of the mixing tank 3; the mixing shaft 5 is inserted into the mixing tank 3 from the top, and the plurality of mixing blades 4 are provided in the mixing tank 3 along the mixing shaft 5.

In manufacturing a glass substrate, a mixing function in a platinum channel may make a molten glass liquid that has an uneven composition more homogeneous, henceforth reducing a stripe defect in a finished glass substrate. Glass homogenization may include a chemical homogeneity and a thermal homogeneity. Different chemical phase stripes in a glass melting furnace may be caused by refractory material dissolution, melt layering, glass surface volatilization, and temperature differences during a melting process. Color or refractive index of a manufactured glass may have differences. Platinum-rhodium defects in glass manufacturing with dimensions less than 50 μm may originate from corrosion of a mixer and a wall of a mixing tank caused by viscous shear stresses in the mixer.

A homogenization mechanism may include: (1) stretching a non-homogeneous phase into thin strips by applying a shear stress to a glass melt; (2) cutting the stripes into short fragments by a plane of blades of the mixer perpendicular to a direction of flow of the glass melt; and (3) dispersing the fragments by a shape of the blades pushing the glass melt perpendicularly to an overall flow direction to produce a radial flow of the glass.

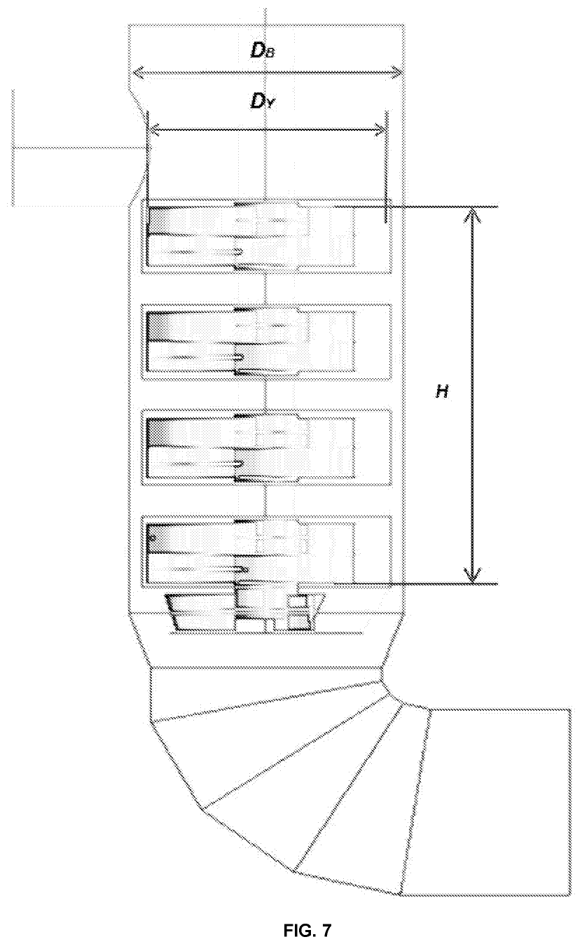

FIG. 7 is a schematic diagram illustrating an exemplary cross-sectional design dimension of a mixing system according to some embodiments of the present disclosure.

As shown in FIG. 7, H denotes a swept height of a blade of an actual mixing system (may also be called a swept range); D_{B} denotes an inner diameter of a mixing tank of the actual mixing system; and D_{Y} denotes a mixing diameter of a blade of the actual mixing system. Maximize mixing may be realized by using a smallest mixing system and a cost of precious metals such as platinum and rhodium may be reduced. By coordinating a relationship between a speed of the mixer, a shape of the mixer or the mixing tank, and a viscosity of a glass, the shear stress may be reduced below a level where unacceptable platinum-rhodium defects are formed while maintaining mixing efficiencies and flow rates at a level where only high shear stresses can realize, thereby achieving a purpose of coordinating the contradiction between shear stress, flow rate, and mixing efficiency.

The swept height H of the blade of the actual mixer may be represented as:

$$1 \leq \frac{H}{{H}_{0}} \leq 1.2 .$$

The blade diameter D_{Y} of the actual mixer may be represented as follows:

$$\frac{{D}_{Y}}{{D}_{Y 0}} = \frac{Q}{{Q}_{0}} \sqrt{\frac{{P}_{0}}{P} \times \frac{{H}_{0}}{H}} = \frac{Q}{{Q}_{0}} \sqrt{\frac{{N}_{0}}{N} \times \frac{{T}_{0}}{T} \times \frac{{H}_{0}}{H}} .$$

The inner diameter D_{B} of the actual mixing tank may be represented as follows:

$${D}_{B} = {D}_{Y} + ( {D}_{B 0} - {D}_{Y 0} ) \times \frac{N}{{N}_{0}} \times \frac{{D}_{Y}}{{D}_{Y 0}} .$$

N denotes a rotation speed of the actual mixer, D_{Y} denotes the blade diameter of the actual mixer, D_{B} denotes the inner diameter of the actual mixing tank, N₀ denotes the speed of the mixer, D_{Y0} denotes a blade diameter of the mixer, D_{B0} denotes an inner diameter of a mixing tank, H₀ denotes a reference swept height of a blade of a mixer of a mixing system; T denotes a torque of the actual mixer, P denotes a power of the actual mixer, H denotes a swept height of the actual mixer, Q denotes an actual pull amount, T₀ denotes a torque of the mixer, P₀ denotes a power of the mixer, H₀ denotes a swept height of the blade of the mixer, and Q₀ denotes a pull amount.

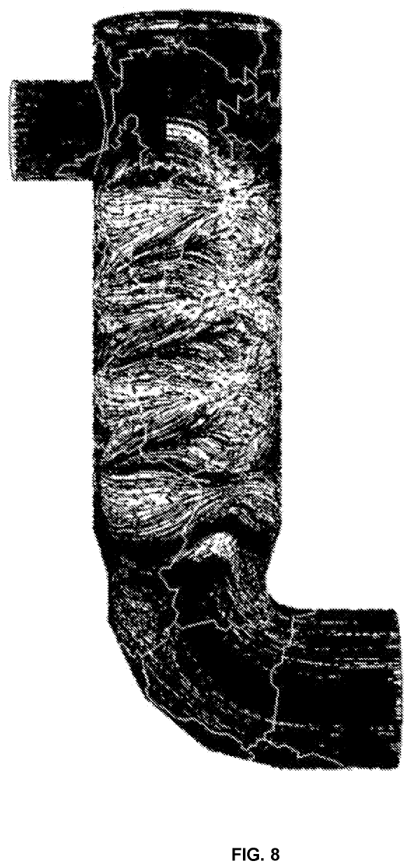

FIG. 8 is a schematic diagram illustrating an exemplary simulated mixing effect according to some embodiments of the present disclosure.

As shown in FIG. 8, numerical analysis software specialized in fluid dynamics (e.g., Ansys-Fluent) may be applied to carry out the coupled calculation of thermal field and flow field for a platinum channel mixing system. An optimal rotation speed of a mixer is obtained by studying a flow and temperature fields of a molten glass liquid in a mixing drum and analyzing a regulation of a flow pattern of the glass liquid in the mixing drum and of homogenization effect.

A proper (not excessive) shear stress may achieve a low platinum defect rate and a high mixing (homogenization) efficiency. Mixing at a given flow rate Q produces moderate homogenization as the goal, shear stress reduction should not be at the expense of mixing efficiency, and minimizing corrosion can extend the life of the mixing system. For a given flow rate Q, keeping mixing efficiency constant and reducing shear stresses usually requires increasing a diameter of the mixer or a mixing volume and keeping H as a constant. In practice, this means increasing a retention time, which maintains full homogenization of the glass melt even at a slower mixing speed. A torque T has to be kept low enough to avoid significant creep of the mixer shaft due to a torque stress at a mixing temperature.

In some embodiments, when the mixing system is in operation, a mixer, driven by the transmission mechanism, rotates uniformly at a set rotation speed, thereby mixing the molten glass liquid that enters the mixing tank 3 through the inlet end 1. The molten glass liquid itself is thermally conductive, and it is possible that the temperature of the molten glass liquid in the back section of the mixing tank 3 has already reached the same temperature.

A reference mixing system may be set as follows. An inner diameter of a mixing tank D_{B0} is 360 mm, a blade diameter of a mixer D_{Y0} is 300 mm, a swept height of a blade of the mixer H₀ is 610 mm, a rotation speed of the mixer N₀ is 8 rpm, and a pull amount Q₀ is 22 T/Day.

An actual mixing system may be designated as follows. A rotation speed of an actual mixer Nis 8 rpm, and an actual pull amount Q is 28 T/Day.

Assuming

$$\frac{H}{{H}_{0}} = 1.2 ,$$

the motor and rate a power Pare the same as that of the reference mixing system, and the rotation speed Nis the same as that of the reference mixing system, then for the actual mixing system, the inner diameter of the mixing tank D_{B} is 460.1 mm, a maximum diameter of the blade of the mixer D_{Y} is 383.41 mm, and the swept height of the blade of the mixer His 732 mm.

In order to verify an equivalence of shear stresses, shear stresses of the reference mixing system and the actual mixing system were calculated as:

$$\frac{N \cdot {D}_{Y}}{{D}_{B} - {D}_{Y}} = \frac{{N}_{0} \cdot {D}_{Y 0}}{{D}_{B 0} - {D}_{Y 0}} \approx 40 .$$

In order to verify an equivalence of the mixing effect, mixing effects of the reference mixing system and the actual mixing system were calculated as:

$$\frac{{D}_{Y}^{2} \cdot H}{{Q}^{2}} = \frac{{D}_{Y 0}^{2} \cdot {H}_{0}}{{Q}_{0}^{2}} \approx 1.1342975 \times 1 {0}^{- 4} .$$

In some embodiments of the present disclosure, the actual mixing system is designed to have the same mixing effect as the reference mixing system, taking into account the creep of the mixing shaft and the optimization of the cost of the system, which meets the technical requirements of high efficiency and high homogenization mixing and for the needs of higher generations and higher pull amount.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and modifications are intended to be suggested by this disclosure and are within the spirit and scope of the exemplary embodiments of this disclosure.

These alterations, improvements, and modifications are intended to be suggested by this disclosure and are within the spirit and scope of the exemplary embodiments of this disclosure. For example, the terms “one embodiment,” “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of the present disclosure are not necessarily all referring to the same embodiment. In addition, some features, structures, or characteristics of one or more embodiments in the present disclosure may be properly combined.

Furthermore, the recited order of processing elements or sequences, or the use of numbers, letters, or other designations, therefore, is not intended to limit the claimed processes and methods to any order except as may be specified in the claims. Although the above disclosure discusses some embodiments of the invention currently considered useful by various examples, it should be understood that such details are for illustrative purposes only, and the additional claims are not limited to the disclosed embodiments. Instead, the claims are intended to cover all combinations of corrections and equivalents consistent with the substance and scope of the embodiments of the invention. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes. History application documents that are inconsistent or conflictive with the contents of the present disclosure are excluded, as well as documents (currently or subsequently appended to the present disclosure) limiting the broadest scope of the claims of the present disclosure. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A system for designing a manufacturing and mixing system of a glass substrate, comprising:
an initial module, configured to obtain at least one reference design parameter from a reference mixing system, establish an equivalence relationship based on a preset rule, and determine at least one initial design parameter of an actual mixing system based on the equivalence relationship, the equivalence relationship including a mechanical equivalence relationship and an effect equivalence relationship;
a prediction module, configured to predict, based on the at least one initial design parameter, a predicted mixing effect of the actual mixing system when processing a glass melt, and in response to a determination that a first matching degree between the predicted mixing effect and a target mixing effect satisfies a preset condition, generate a verification instruction and send the verification instruction to a verification module;
wherein the verification module is configured to:
in response to receiving the verification instruction, initiate a verification action to determine a verification mixing effect, and determine a second matching degree between the verification mixing effect and the target mixing effect;
in response to a determination that the second matching degree does not satisfy the preset condition, determine at least one optimized design parameter by performing at least one round of update on the at least one initial design parameter in cooperation with an update module; or
in response to a determination that the second matching degree satisfies the preset condition, determine the at least one initial design parameter as the at least one optimized design parameter; and,
establish a communication connection with an external test system, the external test system comprising a test terminal and an inspection device, the test terminal being configured to send a test instruction to the verification module and receive a manufacturing instruction from the verification module;
a pre-processing module, configured to:
convert the at least one optimized design parameter into a reference code using an encoder, obtain a label corresponding to reference melt data from a first database in a memory, store the reference code and the label in a second database in the memory, the reference melt data being data of the glass melt corresponding to the at least one optimized design parameter; and
a recommendation module, configured to:
determine, based on a user input, initial melt data of a glass melt to be processed and determine a target label from the first database;
determine a target code based on the target label, convert the target code into at least one target design parameter using a decoder corresponding to the encoder; and
generate a design simulation diagram corresponding to the at least one target design parameter based on the at least one target design parameter and a simulation instruction, and display the design simulation diagram through a user terminal; wherein
the user input is obtained through the user terminal and includes at least one of the initial melt data or the simulation instruction.

2. The system of claim 1, wherein the verification action comprises:
sending the manufacturing instruction to the test terminal, and in response to receiving the test instruction, collecting, via the inspection device in real-time, first inspection data when the actual mixing system processes the glass melt; and
determining the verification mixing effect based on the first inspection data.

3. The system of claim 1, wherein the at least one round of update comprises:
determining an updated mixing effect by performing the verification action based on the verification instruction from the update module, the verification instruction comprising at least one updated design parameter, and the at least one updated design parameter being obtained by the update module by updating at least one update parameter to be updated based on an update step length;
in response to determining that a third matching degree between the updated mixing effect and the target mixing effect does not satisfy the preset condition, determining an update instruction and sending the update instruction to the update module for a next round of update; or
in response to determining that the third matching degree between the updated mixing effect and the target mixing effect satisfies the preset condition, determining an abort instruction and sending the abort instruction to the update module to stop the update, and determining the at least one updated design parameter as the at least one optimized design parameter.

4. The system of claim 1, wherein an equation of the mechanical equivalence relationship is:
$$\frac{N \cdot {D}_{Y}}{{D}_{B} - {D}_{Y}} = \frac{{N}_{0} \cdot {D}_{Y 0}}{{D}_{B 0} - {D}_{Y 0}}$$
where N denotes a rotation speed of a mixer, D_{Y} denotes a blade diameter of the mixer, D_{B} denotes an inner diameter of a mixing tank of the mixer, N₀ denotes a reference rotation speed, D_{Y0} denotes a reference blade diameter, and D_{B0} denotes a reference inner diameter of a mixing tank.

5. The system of claim 4, wherein a shear stress in the mechanical equivalence relationship is proportional to a viscosity of a glass, the rotation speed of the mixer, and the blade diameter of the mixer, and the shear stress is inversely proportional to a gap between a blade of the mixer and an inner wall of the mixing tank.

6. The system of claim 5, wherein the gap between the blade of the mixer and the inner wall of the mixing tank is determined based on the inner diameter of the mixing tank and the blade diameter of the mixer.

7. The system of claim 1, wherein an equation of the effect equivalence relationship is:
$$\frac{N \cdot T \cdot {D}_{Y}^{2} \cdot H}{{Q}^{2}} = \frac{{N}_{0} \cdot {T}_{0} \cdot {D}_{Y 0}^{2} \cdot {H}_{0}}{{Q}_{{0}^{2}}}$$
$$or \frac{P \cdot {D}_{Y}^{2} \cdot H}{{Q}^{2}} = \frac{{P}_{0} \cdot {D}_{Y 0}^{2} \cdot {H}_{0}}{{Q}_{0}^{2}} ,$$
where T denotes a torque of a mixer, P denotes a power of the mixer, H denotes a swept height of a blade of the mixer, Q denotes a pull amount, T₀ denotes a reference torque, P₀ denotes a reference power, H₀ denotes a reference swept height of a blade, and Q₀ denotes a reference pull amount.

8. The system of claim 7, wherein a mixing effect E in the effect equivalence relationship satisfies a following relationship:
$$E ∝ \sqrt{\frac{C \cdot \vert τ \vert \cdot T \cdot {D}_{Y} \cdot H}{η}} .$$

9. The system of claim 8, wherein a ratio between the swept height of the blade of the mixer and the reference swept height of the blade is in a range of [1,1.2].

10. The system of claim 9, wherein an equation for determining a blade diameter D_{Y} of the mixer is:
$$\frac{{D}_{Y}}{{D}_{Y 0}} = \frac{Q}{{Q}_{0}} \sqrt{\frac{{P}_{0}}{P} \times \frac{{H}_{0}}{H}} = \frac{Q}{{Q}_{0}} \sqrt{\frac{{N}_{0}}{N} \times \frac{{T}_{0}}{T} \times \frac{{H}_{0}}{H}} .$$

11. The system of claim 10, wherein an equation for determining an inner diameter D_{B} of a mixing tank is:
$${D}_{B} = {D}_{Y} + ( {D}_{B 0} - {D}_{Y 0} ) \times \frac{N}{{N}_{0}} \times \frac{{D}_{Y}}{{D}_{Y 0}} .$$

12. The system of claim 1, wherein the prediction module is further configured to:
determine the predicted mixing effect based on reference melt data and the at least one initial design parameter using a first prediction model, the first prediction model being a machine learning model.

13. The system of claim 2, wherein the verification module is further configured to:
determine the verification mixing effect based on the first inspection data using a second prediction model, the second prediction model being a machine learning model.

14. The system of claim 3, wherein the update step length is determined based on a preset parameter range and an update round threshold.

15. The system of claim 13, wherein the verification module is further configured to:
obtain at least one current mixing parameter and second inspection data corresponding to the at least one current mixing parameter; and
in response to a determination that a fourth matching degree between an actual mixing effect corresponding to the second inspection data and the target mixing effect does not satisfy the preset condition, determine at least one updated mixing parameter using a parameter adjustment model, the parameter adjustment model being a machine learning model.

16. A method for designing a manufacturing and mixing system of a glass substrate, wherein the method is performed by a system for designing a manufacturing and mixing system of a glass substrate, comprising:
obtaining at least one reference design parameter from a reference mixing system, establishing an equivalence relationship based on a preset rule, and determining at least one initial design parameter of an actual mixing system based on the equivalence relationship, the equivalence relationship including a mechanical equivalence relationship and an effect equivalence relationship;
predicting a predicted mixing effect of the actual mixing system when processing a glass melt based on the at least one initial design parameter, and in response to a determination that a first matching degree between the predicted mixing effect and a target mixing effect satisfies a preset condition, generating a verification instruction and sending the verification instruction to a verification module;
in response to receiving the verification instruction, initiating a verification action to determine a verification mixing effect, determining a second matching degree between the verification mixing effect and the target mixing effect;
in response to a determination that the second matching degree dose not satisfy the preset condition, determine at least one optimized design parameter by perform at least one round of update on the at least one initial design parameter in cooperation with an update module;
in response to a determination that the second matching degree satisfies the preset condition, determining the at least one initial design parameter as the at least one optimized design parameter;
converting the at least one optimized design parameter into a reference code using an encoder, obtaining a label corresponding to reference melt data from a first database in a memory, storing the reference code and the label in a second database in the memory, and the reference melt data being data of the glass melt corresponding to the at least one optimized design parameter;
determining, based on user input, initial melt data of a glass melt to be processed and determining a target label from the first database;
determining a target code based on the target label, converting the target code into at least one target design parameter using a decoder corresponding to the encoder; and
growing a design simulation diagram corresponding to the at least one target design parameter based on the at least one target design parameter and a simulation instruction, and displaying the design simulation diagram via a user terminal; wherein,
the user input is obtained through the user terminal and includes at least one of the initial melt data or the simulation instruction.

17. A computer-readable storage medium, wherein the storage medium stores computer instructions, and when a computer reads the computer instructions in the storage medium, the computer executes a method for designing a manufacturing and mixing system of a glass substrate of claim 16.
